(19) United States
(12) Patent Application Publication
(10) Pub. No.: US 2015/0372292 A1
(43) Pub. Date: Dec. 24, 2015

(54) NEGATIVE ELECTRODE ACTIVE MATERIAL FOR NONAQUEOUS ELECTROLYTE SECONDARY BATTERY, NEGATIVE ELECTRODE FOR NONAQUEOUS ELECTROLYTE SECONDARY BATTERY USING NEGATIVE ELECTRODE ACTIVE MATERIAL, AND NONAQUEOUS ELECTROLYTE SECONDARY BATTERY USING NEGATIVE ELECTRODE

(71) Applicant: SANYO ELECTRIC CO., LTD., Daito-shi, Osaka (JP)

(72) Inventors: Mai Yokoi, Tokushima (JP); Hiroshi Minami, Hyogo (JP); Naoki Imachi, Hyogo (JP); Yoshio Kato, Hyogo (JP)

(73) Assignee: SANYO Electric Co., Ltd., Daito-shi, Osaka (JP)

(21) Appl. No.: 14/759,062

(22) PCT Filed: Jan. 24, 2014
(86) PCT No.: PCT/JP2014/000210

§ 371 Date: Jul. 2, 2015

(30) Foreign Application Priority Data
Jan. 30, 2013 (JP) 2013-015321

(51) Int. Cl. H01M 4/36; H01M 10/0525

(52) U.S. Cl. CPC H01M 4/366; H01M 10/0525

(57) ABSTRACT

In nonaqueous electrolyte secondary batteries that use silicon oxide as a negative electrode active material, the cycle characteristics are improved. A negative electrode active material (13a) includes a base particle (14) composed of silicon oxide and a coating layer (15) that is composed of a conductive carbon material and coats at least part of a surface of the base particle (14). Assuming that a maximum peak intensity at 600 cm⁻¹ to 1400 cm⁻¹ in an infrared absorption spectrum obtained by infrared spectroscopic measurement is 1, an intensity at 900 cm⁻¹ is 0.30 or more, and a full width at half maximum of a peak near 1360 cm⁻¹ in a Raman spectrum obtained by Raman spectroscopic measurement is 100 cm⁻¹ or more.

### TECHNICAL FIELD

The present invention relates to a negative electrode active material for nonaqueous electrolyte secondary batteries, a negative electrode for nonaqueous electrolyte secondary batteries using the negative electrode active material, and a nonaqueous electrolyte secondary battery using the negative electrode.

### BACKGROUND ART

A study on using, as a high-capacity negative electrode active material, a silicon oxide (SiOₓ) that forms an alloy with a lithium ion (Li⁺) and has a theoretical capacity per unit weight of about 2680 mAh/g has been conducted. For example, PTL 1 proposes a nonaqueous electrolyte secondary battery that uses a negative electrode active material prepared by mixing SiOₓ and graphite.

### CITATION LIST

### Patent Literature

PTL 1: Japanese Published Unexamined Patent Application No. 2010-212228

### SUMMARY OF INVENTION

### Technical Problem

However, when SiOₓ is used as a negative electrode active material, the electrode resistance readily increases as a result of a side reaction and thus good cycle characteristics are not achieved.

### Solution to Problem

A negative electrode active material for a nonaqueous electrolyte secondary battery according to the present invention is a particulate negative electrode active material used for a nonaqueous electrolyte secondary battery. The negative electrode active material includes a base particle composed of silicon oxide and a coating layer that is composed of a conductive carbon material and coats at least part of a surface of the base particle. Assuming that a maximum peak intensity at 600 cm⁻¹ to 1400 cm⁻¹ in an infrared absorption spectrum obtained by infrared spectroscopic measurement is 1, an intensity at 900 cm⁻¹ is 0.30 or more, and a full width at half maximum of a peak near 1360 cm⁻¹ in a Raman spectrum obtained by Raman spectroscopic measurement is 100 cm⁻¹ or more.

A negative electrode for a nonaqueous electrolyte secondary battery according to the present invention includes a negative electrode current collector and a negative electrode active material layer that is formed on the negative electrode current collector and that contains the negative electrode active material.

A nonaqueous electrolyte secondary battery according to the present invention includes the negative electrode, a positive electrode, and a nonaqueous electrolyte.

### Advantageous Effects of Invention

According to the present invention, in nonaqueous electrolyte secondary batteries that use SiOₓ as a negative electrode active material, the cycle characteristics can be improved.

### BRIEF DESCRIPTION OF DRAWINGS

FIG. 1 is a cross-sectional view illustrating a negative electrode according to an embodiment of the present invention.

FIG. 2 is a cross-sectional view illustrating a negative electrode active material particle according to an embodiment of the present invention.

FIG. 3 shows an infrared absorption spectrum of negative electrode active material particles according to an embodiment of the present invention.

FIG. 4 is a cross-sectional view illustrating an example of a known negative electrode active material particle.

FIG. 5 shows infrared absorption spectra of negative electrode active material particles used in Example and Comparative Example.

FIG. 6 shows infrared absorption spectra of negative electrode active material particles used in Examples.

### DESCRIPTION OF EMBODIMENTS

Hereafter, embodiments of the present invention will be described in detail.

The drawings (except for spectra) referred to in the description of the embodiments are schematically illustrated. For example, the dimensional ratio of an element illustrated in the drawings may be different from that of the actual element. The specific dimensional ratio or the like should be judged in consideration of the following description.

In this Description, the meaning of “substantially **” is that, when “substantially the same” is taken as an example, “substantially the same” is intended to include not only “exactly the same”, but also “virtually the same”.

A nonaqueous electrolyte secondary battery according to an embodiment of the present invention includes a positive electrode containing a positive electrode active material, a negative electrode containing a negative electrode active material, and a nonaqueous electrolyte containing a nonaqueous solvent. A separator is suitably disposed between the positive electrode and the negative electrode. For example, the nonaqueous electrolyte secondary battery has a structure in which an electrode body obtained by winding a positive electrode and a negative electrode with a separator disposed therebetween and a nonaqueous electrolyte are accommodated in an exterior body.

### [Positive Electrode]

The positive electrode suitably includes a positive electrode current collector and a positive electrode active material layer formed on the positive electrode current collector. The positive electrode current collector is composed of, for example, a conductive thin film such as a metal foil or alloy foil of aluminum or the like which is stable in the potential range of a positive electrode or a film including a metal surface layer composed of aluminum or the like. The positive electrode active material layer preferably contains a conductive material and a binding agent, in addition to the positive electrode active material.

The positive electrode active material is not particularly limited, but is preferably a lithium transition metal oxide. The lithium transition metal oxide may contain a non-transition metal element such as Mg or Al. Specific examples of the lithium transition metal oxide include lithium cobaltate, olivine lithium phosphate such as lithium iron phosphate, and lithium transition metal oxides such as Ni—Co—Mn, Ni—Mn—Al, and Ni—Co—Al. These positive electrode active materials may be used alone or in combination of two or more.

The conductive material may be a carbon material such as carbon black, acetylene black, Ketjenblack, or graphite or a mixture of two or more of the foregoing. The binding agent may be polytetrafluoroethylene, polyvinylidene fluoride, polyvinyl acetate, polyacrylonitrile, or polyvinyl alcohol or a mixture of two or more of the foregoing.

### [Negative Electrode]

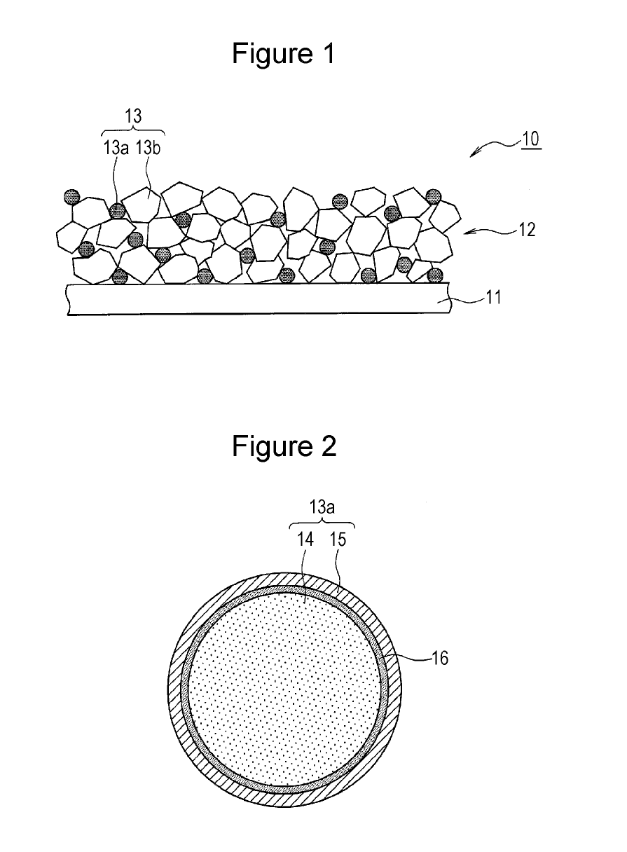

As illustrated in FIG. 1, a negative electrode 10 suitably includes a negative electrode current collector 11 and a negative electrode active material layer 12 formed on the negative electrode current collector 11. The negative electrode current collector 11 is composed of, for example, a conductive thin film such as a metal foil or alloy foil of copper or the like which is stable in the potential range of a negative electrode or a film including a metal surface layer composed of copper or the like. The negative electrode active material layer 12 suitably includes a binding agent (not illustrated) in addition to the negative electrode active material 13. The binding agent may be polytetrafluoroethylene or the like as in the case of the positive electrode, but is preferably styrene-butadiene rubber (SBR), polyimide, or the like. The binding agent may be used together with a thickener such as carboxymethyl cellulose.

A negative electrode active material 13a is used as the negative electrode active material 13. The negative electrode active material 13a includes a base particle 14 composed of silicon oxide (SiOₓ) and a conductive coating layer 15 that coats at least part of the surface of the base particle 14. The negative electrode active material 13a may be used alone as the negative electrode active material 13, but is suitably used in combination with another negative electrode active material 13b whose volume change due to charge and discharge is smaller than that of the negative electrode active material 13a in view of achieving both an increase in capacity and an improvement in cycle characteristics. The negative electrode active material 13b is not particularly limited, but is preferably a carbon-based active material such as graphite or hard carbon.

In the case where the negative electrode active material 13a and the negative electrode active material 13b are used in combination, for example, if the negative electrode active material 13b is graphite, the mass ratio of the negative electrode active material 13a to the graphite is preferably 1:99 to 20:80. When the mass ratio is within the above range, both an increase in capacity and an improvement in cycle characteristics are easily achieved. If the percentage of the mass of the negative electrode active material 13a relative to the total mass of the negative electrode active material 13 is less than 1 mass %, an effect of increasing the capacity by adding the negative electrode active material 13a is reduced.

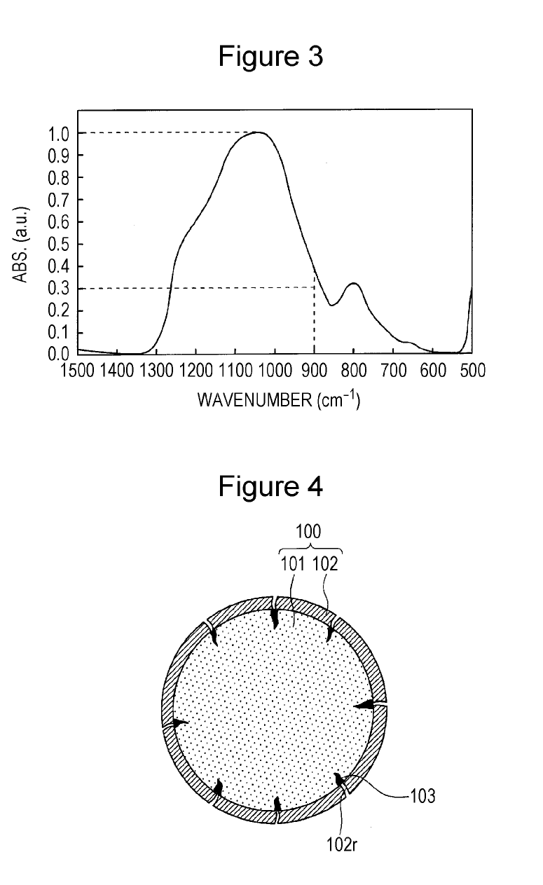

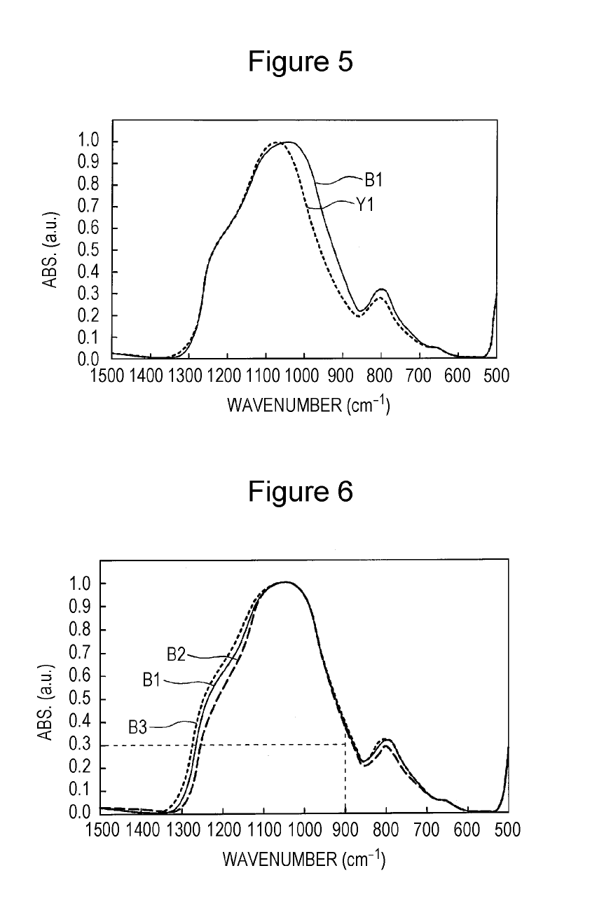

Hereafter, the negative electrode active material 13a will be described in detail with reference to FIGS. 2 and FIG. 3. The infrared absorption spectrum in FIG. 3 is a spectrum (solid line in FIG. 5) of negative electrode active material particles B1 used in Example 1 described below. FIG. 4 illustrates a known carbon-coated SiOₓ particle 100 for comparison. The carbon-coated SiOₓ particle 100 has a structure in which a coating layer 102 composed of a conductive carbon material having high crystallinity is formed on the surface of an SiOₓ particle 101.

As illustrated in FIG. 2, the negative electrode active material 13a has a particulate shape in which the coating layer 15 is formed on the surface of the base particle 14 (hereafter referred to as a “negative electrode active material particle 13a”). The coating layer 15 is suitably formed so as to coat substantially the entire surface of the base particle 14. In FIG. 2, the negative electrode active material particle 13a is illustrated in a spherical shape. However, many of the negative electrode active material particles 13a actually have sharp corners and thus have various shapes such as a block shape, a flat shape, an elongated rod shape, and a needle-like shape. The particle size of the negative electrode active material particle 13a is substantially equal to the particle size of the base particle 14 because the thickness of the coating layer 15 is small as described below.

As described above, the base particle 14 is composed of SiOₓ. SiOₓ (preferably 0.5×1.5) has, for example, a structure in which Si is dispersed in an amorphous SiO₂ matrix. The presence of the dispersed Si can be confirmed through observation with a transmission electron microscope (TEM). SiOₓ can occlude a larger amount of Li⁺ and has a higher capacity per unit volume than carbon materials such as graphite, and thus contributes to an increase in the capacity. However, SiOₓ has low electron conductivity and easily causes an increase in electrode resistance due to a side reaction, which are characteristics unsuitable for negative electrode active materials. In the negative electrode active material particle 13a, such drawbacks are overcome by employing the coating layer 15 and a surface film 16 described below.

SiOₓ constituting the base particle 14 may contain lithium silicate (e.g., Li₄SiO₄, Li₂SiO₂, Li₂Si₂O₅, and Li₈SiO₅) in the particle.

The average particle size of the base particles 14 is preferably 1 to 15 μm and more preferably 4 to 10 μm in view of achieving an increase in capacity. In this Description, the term “average particle size” refers to a particle size (volume-average particle size, Dv₅₀) at which the volume-based cumulative distribution reaches 50% in the particle size distribution measured by a laser diffraction/scattering method. Dv₅₀ can be measured with, for example, “LA-750” manufactured by HORIBA, Ltd. If the particle size of the base particles 14 is excessively decreased, the surface area of the particles increases. As a result, the amount of reaction with an electrolyte increases, which tends to decrease the capacity. If the particle size is excessively increased, Li⁺ is unable to diffuse to the vicinity of the center of SiOₓ. As a result, the capacity decreases and the load characteristic tends to degrade.

The coating layer 15 is a conductive layer composed of a conductive carbon material (hereafter simply referred to as a “carbon material”). The coating layer 15 is preferably composed of a carbon material having low crystallinity and high permeability of an electrolytic solution. The carbon material is formed using, as a raw material, for example, coal tar, tar pitch, naphthalene, anthracene, or phenanthrolene and preferably coal-based coal tar or petroleum tar pitch. The specific resistance of the carbon material is preferably 10 kΩcm or less and more preferably 5 kΩcm or less.

The average thickness of the coating layer 15 is preferably 1 to 200 nm and more preferably 5 to 100 nm in consideration of ensuring of conductivity and diffusion of Li⁺ to SiOₓ constituting the base particle 14. The coating layer 15 suitably has a substantially uniform thickness across its entire region. The average thickness of the coating layer 15 can be measured by cross-sectional observation of the negative electrode active material particle 13a using a scanning electron microscope (SEM), a TEM, or the like. If the thickness of the coating layer 15 is excessively decreased, the conductivity decreases, which makes it difficult to uniformly coat the base particle 14. If the thickness of the coating layer 15 is excessively increased, the diffusion of Li⁺ to the base particle 14 is inhibited, which tends to decrease the capacity.

In the negative electrode active material particles 13a, assuming that the maximum peak intensity Iₘₐₓ at 600 cm⁻¹ to 1400 cm⁻¹ in an infrared absorption spectrum (hereafter referred to as a “predetermined IR spectrum”) obtained by infrared spectroscopic measurement (hereafter referred to as an “IR measurement”) is 1, the intensity I₉₀₀ at 900 cm⁻¹ is 0.30 or more and the full width at half maximum of a peak near 1360 cm⁻¹ of a Raman spectrum obtained by Raman spectroscopic measurement is 100 cm⁻¹ or more. On the other hand, in the predetermined IR spectrum of carbon-coated SiOₓ particles 100, I₉₀₀/Iₘₐₓ is less than 0.30 as described in Comparative Examples below.

In the predetermined Raman peak of the carbon-coated SiOₓ particles 100, the full width at half maximum is less than 100 cm⁻¹ as described in Comparative Examples below.

That is, in the negative electrode active material particles 13a, the intensity ratio (I₉₀₀/Iₘₐₓ) is 0.30 or more, which is the ratio of the intensity I₉₀₀ at 900 cm⁻¹ to the maximum peak intensity Iₘₐₓ in the predetermined IR spectrum. The negative electrode active material particles 13a have a higher intensity ratio (I₉₀₀/Iₘₐₓ) and preferably have a larger full width at half maximum of the maximum peak in the predetermined IR spectrum than known carbon-coated SiOₓ particles 100 illustrated in FIG. 4. In the predetermined IR spectra of the negative electrode active material particles 13a and the carbon-coated SiOₓ particles 100, for example, a maximum peak having a peak top (Iₘₐₓ) at 950 cm⁻¹ to 1100 cm⁻¹ is observed.

The predetermined IR spectrum of the negative electrode active material particles 13a indicates an Si—O bonding state in the base particles 14. In other words, the difference in the form of the predetermined IR spectrum (intensity ratio (I₉₀₀/Iₘₐₓ)) between the negative electrode active material particles 13a and the carbon-coated SiOₓ particles 100 means that the Si—O bonding state in the base particles 14 is different from that in the SiOₓ particles 101. Specifically, it is assumed that the base particles 14 have an ambiguous Si—O bonding state compared with the SiOₓ particles 101, that is, the base particles 14 have a large variation in bond strength.

Since the negative electrode active material particles 13a have distinctive features such as the above-described Si—O bonding state and a coating layer 15 having high permeability of an electrolytic solution, a surface film 16 described below is formed on the surface of each of the base particles 14 and thus the cycle characteristics are improved. The reason why the structure of the negative electrode active material particles 13a is identified by the intensity ratio (I₉₀₀/Iₘₐₓ) is that the intensity ratio (I₉₀₀/Iₘₐₓ) does not easily vary in accordance with, for example, the heat treatment conditions during the formation of the coating layer 15. The full width at half maximum of the maximum peak in the predetermined IR spectrum varies to some extent in accordance with, for example, the heat treatment conditions (refer to FIG. 6).

In the predetermined IR spectrum of the negative electrode active material particles 13a, the intensity ratio (I₉₀₀/Iₘₐₓ) is 0.3 or more, preferably 0.35 or more, and more preferably 0.35 to 0.45. When the intensity ratio (I₉₀₀/Iₘₐₓ) is within the above range, a good surface film 16 is easily formed, which can improve the cycle characteristics.

The predetermined IR spectrum of the negative electrode active material particles 13a can be measured using a commercially available IR spectrometer. An example of a suitable IR spectrometer is “Spectrum One” manufactured by PerkinElmer Co., Ltd. The measurement method is preferably a Nujol mull method or a KBr method. Both the measurement methods produce the same result.

The base particles 14 having the distinctive predetermined IR spectrum are prepared by, for example, mixing Si and SiO₂ at a molar ratio of 0.5:1.5 to 1.5:0.5 and preferably about 1:1 and heat-treating the mixture in a reduced pressure at 750° C. to 1150° C. and preferably 800° C. to 1100° C. As a result of the heat treatment, a polycrystalline SiOₓ block is obtained. The polycrystalline SiOₓ block is crushed and classified to prepare SiOₓ particles (base particles 14) having an average particle size of, for example, 1 to 15 μm.

In the negative electrode active material particles 13a, as described above, the full width at half maximum of a peak near 1360 cm⁻¹ of a Raman spectrum obtained by Raman spectroscopic measurement is 100 cm⁻¹ or more. Herein, the peak near 1360 cm⁻¹ refers to a peak that appears at 1360 cm⁻¹ or, when no peak appears at 1360 cm⁻¹, a peak whose peak top appears closest to 1360 cm⁻¹. Hereafter, the peak near 1360 cm⁻¹ of a Raman spectrum is referred to as a “predetermined Raman peak”.

The crystallinity of the carbon material constituting the coating layer 15 can be confirmed from the predetermined Raman peak of the negative electrode active material particles 13a. In other words, the difference in the form of the predetermined Raman peak between the negative electrode active material particles 13a and the carbon-coated SiOₓ particles 100 means that the crystallinity of the carbon material constituting the coating layer 15 is different from that of the carbon material constituting the coating layer 102. Specifically, the full width at half maximum of the predetermined Raman peak of the negative electrode active material particles 13a is as large as 100 cm⁻¹ or more, and thus the carbon material constituting the coating layer 15 has a crystallinity lower than that of the carbon material constituting the coating layer 102.

In the coating layer 15, cracks which may be caused by a volume change in the base particles 14 due to charge and discharge are not easily generated. In the coating layer 102 of the carbon-coated SiOₓ particles 100, cracks 102r are easily generated as a result of a volume change in the base particles 14. This comes from the difference in crystallinity between the carbon materials constituting the coating layers. Furthermore, the coating layer 15 has a higher permeability of an electrolytic solution than the coating layer 102. It is believed that, in the carbon-coated SiOₓ particles 100, the SiOₓ particles 101 and the electrolytic solution are locally in direct contact with each other in portions where cracks 102r are generated whereas, in the negative electrode active material particles 13a, an electrolytic solution that permeates through the coating layer 102 is uniformly brought into contact with the entire surface of each of the base particles 14.

In the predetermined Raman peak of the negative electrode active material particles 13a, the full width at half maximum is 100 cm⁻¹ or more, preferably 120 cm⁻¹ or more, and more preferably 120 cm⁻¹ to 170 cm⁻¹. When the full width at half maximum of the predetermined Raman peak is within the above range, a good surface film 16 is easily formed, which can improve the cycle characteristics.

The Raman spectrum of the negative electrode active material particles 13a can be measured using a commercially available Raman spectrometer. An example of a suitable Raman spectrometer is a microlaser Raman spectrometer “Lab RAM ARAMIS” manufactured by HORIBA, Ltd.

The coating layer 15 having the distinctive predetermined Raman peak is prepared by, for example, immersing, in a solution of coal tar or the like, base particles 14 to be coated and then performing a high-temperature treatment in an inert atmosphere. The heat treatment temperature is preferably about 900° C. to 1100° C.

In the negative electrode active material particles 13a, as described above, the intensity ratio (I₉₀₀/Iₘₐₓ) in the predetermined IR spectrum is 0.30 or more and the full width at half maximum of the predetermined Raman peak is 100 cm⁻¹ or more. This is believed to increase both the reactivity of the base particles 14 with an electrolytic solution and the permeability of an electrolytic solution through the coating layer 15. Because of these characteristics, the surface film 16 is uniformly formed on the surface of each of the base particles 14.

The presence of the surface film 16 can be confirmed from a cross-sectional SEM image of each of the negative electrode active material particles 13a. The surface film 16 is believed to be, for example, a so-called SEI film with lithium ion conductivity, which is formed on the surface of each of the base particles 14 as a result of reductive decomposition of an electrolytic solution during the first charge. The SEI film protects the surface of an active material and reduces a side reaction with an electrolytic solution during charge and discharge performed later. The negative electrode active material particle 13a includes a base particle 14 having a high reactivity with an electrolytic solution and a coating layer 15 through which an electrolytic solution is permeated so as to be uniformly in contact with the entire surface of the base particle 14. Therefore, the surface film 16 is uniformly formed on the surface of the base particle 14. This reduces a side reaction with an electrolytic solution, which is believed to improve the cycle characteristics.

The SEI film is not easily formed on the carbon-coated SiOₓ particles 100. The SiOₓ particles 101 are locally in direct contact with an electrolytic solution in portions where cracks 102r of the coating layer 102 are generated. As illustrated in FIG. 4, partial erosion of the SiOₓ particle 101 can be confirmed from a SEM image in portions of the SiOₓ particle 101 that directly contacts an electrolytic solution.

### [Nonaqueous Electrolyte]

The nonaqueous electrolyte contains a nonaqueous solvent and an electrolyte salt dissolved in the nonaqueous solvent. The nonaqueous electrolyte is not limited to a liquid electrolyte (nonaqueous electrolytic solution), and may be a solid electrolyte that uses a gel polymer or the like. The nonaqueous solvent may be, for example, an ester, an ether, a nitrile (e.g., acetonitrile), or an amide (e.g., dimethylformamide) or a mixed solvent containing two or more of the foregoing.

Examples of the ester include cyclic carbonates such as ethylene carbonate (EC), propylene carbonate, and butylene carbonate; chain carbonates such as dimethyl carbonate, methyl ethyl carbonate, diethyl carbonate (DEC), methyl propyl carbonate, ethyl propyl carbonate, and methyl isopropyl carbonate; and carboxylates such as methyl acetate, ethyl acetate, propyl acetate, methyl propionate, ethyl propionate, and γ-butyrolactone.

Examples of the ether include cyclic ethers such as 1,3-dioxolane, tetrahydrofuran, 2-methyltetrahydrofuran, propylene oxide, 1,2-butylene oxide, 1,3-dioxane, furan, and 1,8-cineole; and chain ethers such as 1,2-dimethoxyethane, ethyl vinyl ether, ethyl phenyl ether, 1,2-diethoxyethane, 1,2-dibutoxyethane, diethylene glycol dimethyl ether, 1,1-dimethoxymethane, 1,1-diethoxyethane, and triethylene glycol dimethyl ether.

Among the solvents listed above, at least a cyclic carbonate is preferably used as the nonaqueous solvent, and both a cyclic carbonate and a chain carbonate are more preferably used. The nonaqueous solvent may also be a halogen substitution product obtained by substituting hydrogen atoms of a solvent with halogen atoms such as fluorine atoms.

The electrolyte salt is preferably a lithium salt. Examples of the lithium salt include LiPF₆, LiBF₄, LiAsF₆, LiN(SO₂CF₃)₂, LiN(SO₂CF₅)₂, and LiPF₆₋ₓ (CₙF₂ₙ₊₁)ₓ (1<x<6, n: 1 or 2). These lithium salts may be used alone or in combination of two or more. The concentration of the lithium salt is preferably 0.8 to 1.8 mol per 1 L of the nonaqueous solvent.

### [Separator]

A porous sheet having ion permeability and an insulating property is used as the separator. Specific examples of the porous sheet include microporous membranes, woven fabrics, and nonwoven fabrics. The separator is suitably made of a polyolefin such as polyethylene or polypropylene.

### EXAMPLES

The present invention will be further described based on Examples, but is not limited to these Examples.

### Example 1

### Production of Positive Electrode

Lithium cobaltate, acetylene black (HS100 manufactured by DENKI KAGAKU KOGYO KABUSHIKI KAISHA), and polyvinylidene fluoride were mixed at a mass ratio of 95:2.5:2.5, and NMP was added thereto. The mixture was stirred with a mixer (T.K. HIVIS MIX manufactured by PRIMIX Corporation) to prepare a slurry for forming a positive electrode active material layer.

Subsequently, the slurry was applied onto both surfaces of an aluminum foil to be a positive electrode current collector so that the mass of the positive electrode active material layer per 1 m² was 500 g. The aluminum foil was then dried at 105° C. in the air and rolled to produce a positive electrode. The packing density of the active material layer was 3.8 g/mL.

### [Preparation of Negative Electrode Active Material Particles B1]

Si and SiO₂ were mixed at a molar ratio of 1:1 and heated to 800° C. in a reduced pressure. An SiOₓ gas generated as a result of the heating was cooled to precipitate a polycrystalline SiOₓ block. Subsequently, the polycrystalline SiOₓ block was crushed and classified to prepare SiOₓ particles (hereafter referred to as “base particles A1”) having an average particle size of 5.8 μm. The average particle size of the base particles A1 was measured with “LA-750” manufactured by HORIBA, Ltd. using water as a dispersion medium (the same applies hereafter).

Subsequently, a coating layer composed of a conductive carbon material was formed on the surface of each of the base particles A1. The coating layer was formed using coal-based coal tar as a carbon source so as to have an average thickness of 50 nm and a percentage of 5 mass % (mass of coating layer/mass of negative electrode active material particle B1). A coal-based coal tar solution prepared by dissolving coal-based coal tar in tetrahydrofuran (mass ratio 25:75) and the base particles A1 were mixed at a mass ratio of 2:5. The resulting mixture was dried at 50° C. and then heat-treated at 1000° C. in an inert atmosphere. Thus, particles B1 (hereafter referred to as “negative electrode active material particles B1”) each including the coating layer formed on the surface of the base particle A1 were prepared.

### [Production of Negative Electrode]

The negative electrode active material particles B1 and graphite were mixed at a mass ratio of 4.5:95.5 to prepare a negative electrode active material. The negative electrode active material, carboxymethyl cellulose (CMC, manufactured by Daicel FineChem Ltd., #1380, degree of etherification: 1.0 to 1.5), and SBR were mixed at a mass ratio of 97.5:1.0:1.5, and water was added as a diluent solvent. The mixture was stirred with a mixer (T.K. HIVIS MIX manufactured by PRIMIX Corporation) to prepare a slurry for forming a negative electrode active material layer.

Subsequently, the slurry was applied onto one surface of a copper foil to be a negative electrode current collector so that the mass of the negative electrode active material layer per 1 m² was 190 g. The copper foil was then dried at 105° C. in the air and rolled to produce a negative electrode. The packing density of the negative electrode active material layer was 1.60 g/mL.

### [Preparation of Nonaqueous Electrolytic Solution]

LiPF₆ was added to a nonaqueous solvent prepared by mixing EC and DEC at a ratio of EC:DEC=3:7 (volume ratio) so that the concentration of LiPF₆ was 1.0 mol/L. Thus, a nonaqueous electrolytic solution was prepared.

### [Production of Test Cell C1]

A tab was attached to each of the electrodes. An electrode body was produced by winding the positive electrode and the negative electrode in a spiral manner with the separator disposed therebetween so that the tabs were located in outermost peripheral portions. The electrode body was inserted into an exterior body composed of an aluminum laminate sheet and vacuum-dried at 105° C. for 2 hours. Subsequently, the nonaqueous electrolytic solution was injected. The opening of the exterior body was sealed to produce a test cell C1. The design capacity of the test cell C1 was 800 mAh.

### [Evaluation of Negative Electrode Active Material Particles B1 and Test Cell C1]

(1) An IR spectrum (predetermined IR spectrum) of the negative electrode active material particles B1 was measured by a method described below to determine the intensity ratio (I₉₀₀/Iₘₐₓ). FIG. 5 (solid line) illustrates a processed IR spectrum of the negative electrode active material particles B1. The intensity ratio (I₉₀₀/Iₘₐₓ) was 0.39.
(2) A Raman spectrum (predetermined Raman peak) of the negative electrode active material particles B1 was measured by a method described below to determine the full width at half maximum of the predetermined Raman peak. The full width at half maximum of the predetermined Raman peak was 123 cm⁻¹.
(3) A cycle test of the test cell C1 was performed by a method described below.

Table 1 collectively shows the evaluation results. The same evaluation was also performed in Examples 2 and 3 and Comparative Examples 1 and 2. Table 1 shows the evaluation results.

### Example 2

Negative electrode active material particles B2 were prepared in the same manner as in Example 1, except that the heat treatment temperature of the heat treatment performed in an inert atmosphere after the base particles A1 and the coal-based coal tar solution were mixed and dried was changed to 900° C. A test cell C2 was produced using the negative electrode active material particles B2.

### Example 3

Negative electrode active material particles B3 were prepared in the same manner as in Example 1, except that the heat treatment temperature of the heat treatment performed in an inert atmosphere after the base particles A1 and the coal-based coal tar solution were mixed and dried was changed to 1100° C. A test cell C3 was produced using the negative electrode active material particles B3.

### Comparative Example 1

A test cell Z1 was produced in the same manner as in Example 1, except that negative electrode active material particles Y1 were prepared by a method described below. FIG. 5 (chain line) shows a processed IR spectrum of the negative electrode active material particles Y1. The intensity ratio (I₉₀₀/Iₘₐₓ) was 0.28.

### [Preparation of Negative Electrode Active Material Particles Y1]

Si and SiO₂ were mixed at a molar ratio of 1:1 and heated at 1200° C. in a reduced pressure. An SiOₓ gas generated as a result of the heating was cooled to precipitate a polycrystalline SiOₓ block. Subsequently, the polycrystalline SiOₓ block was crushed and classified to prepare base particles X1 which were SiOₓ particles having an average particle size of 4.8 μm.

Subsequently, a coating layer composed of a conductive carbon material was formed on the surface of each of the base particles X1. The coating layer was formed by a CVD method at 800° C. using acetylene gas as a carbon source so as to have an average thickness of 50 nm and a percentage of 5 mass %. Thus, negative electrode active material particles Y1 each including the coating layer formed on the surface of the base particle X1 were prepared.

### Comparative Example 2

A test cell Z2 was produced in the same manner as in Example 1, except that negative electrode active material particles Y2 were prepared by a method described below.

### [Preparation of Negative Electrode Active Material Particles Y2]

A coating layer was formed on the surface of each of the base particles X1 using coal-based coal tar as a carbon source so as to have an average thickness of 50 nm and a percentage of 5 mass % (mass of coating layer/mass of negative electrode active material particle B1). A coal-based coal tar solution prepared by dissolving coal-based coal tar in tetrahydrofuran (mass ratio 25:75) and the base particles X1 were mixed at a mass ratio of 2:5. The resulting mixture was dried at 50° C. and then heat-treated at 800° C. in an inert atmosphere. Thus, negative electrode active material particles Y2 each including the coating layer formed on the surface of the base particle X1 were prepared.

### <Measurement and Evaluation of IR Spectrum>

The IR spectrum was measured by the following method to determine the intensity ratio (I₉₀₀/Iₘₐₓ).

Measurement instrument: “Spectrum One” manufactured by PerkinElmer Co., Ltd.

Measurement method: KBr method, transmission IR measurement

Spectrum processing: A spectrum obtained by the transmission IR measurement was converted into absorbance. Positions near 530 cm⁻¹ and 1370 cm⁻¹ were set to baseline points, and the baseline was subtracted.

Calculation of intensity ratio (I₉₀₀/Iₘₐₓ): Assuming that the maximum peak intensity Iₘₐₓ in a predetermined IR spectrum, which is a spectrum in the range of 600 cm⁻¹ to 1400 cm⁻¹ of the processed spectrum, was 1, the intensity ratio (I₉₀₀/Iₘₐₓ) of the intensity I₉₀₀ at 900 cm⁻¹ to the maximum peak intensity Iₘₐₓ was calculated.

### <Measurement and Evaluation of Raman Spectrum>

A Raman spectrum was measured by the following method to determine the full width at half maximum of the predetermined Raman peak.

Measurement instrument: Laser Raman spectrometer “Lab RAM ARAMIS” manufactured by HORIBA, Ltd.

Spectrum processing: In the obtained spectrum, positions near 1100 cm⁻¹ and 1700 cm⁻¹ were set to baseline points, and the baseline was subtracted.

Calculation of full width at half maximum: The full width at half maximum for the intensity of a peak (predetermined Raman peak) near 1360 cm⁻¹ of the processed spectrum was calculated.

### <Evaluation of Battery Performance>

The test cells C1 to C3, Z1, and Z2 were evaluated in terms of cycle characteristics. Table 1 shows the evaluation results together with the spectrum data.

### [Cycle Test]

A cycle test was performed for each of the test cells under the charge-discharge conditions below.

The number of cycles until the capacity reached 80% of the first-cycle discharge capacity was measured and defined as a cycle life. The cycle life is an index based on the assumption that the cycle life of the test cell C1 is 100.

### (Charge-Discharge Conditions)

(1) Constant current charge was performed at a current of 1 It (800 mA) until the voltage of the battery reached 4.2 V. Subsequently, constant voltage charge was performed at a constant voltage of 4.2 V until the current reached 1/20 It (40 mA).
(2) Constant current discharge was performed at a current of 1 It (800 mA) until the voltage of the battery reached 2.75 V.
(3) The pause time between the charge and the discharge was 10 minutes.

TABLE 1

| | Intensity ratio | Full width at half | |
|---|---|---|---|
| | (I₉₀₀/Iₘₐₓ) in | maximum (cm⁻¹) of | |
| | predetermined IR | predetermined | |
| | spectrum | Raman peak | Cycle life |
| Example 1 | 0.39 | 123 | 100 |
| Example 2 | 0.37 | 162 | 109 |
| Example 3 | 0.41 | 125 | 91 |
| Comparative Example 1 | 0.28 | 68 | 79 |
| Comparative Example 2 | 0.28 | 69 | 75 |

As is clear from Table 1, the cycle characteristics of the battery were improved by using the negative electrode active material particles B1 to B3 in which the intensity ratio (I₉₀₀/Iₘₐₓ) in the predetermined IR spectrum was as high as 0.30 or more and the full width at half maximum of the predetermined Raman peak was as large as 100 cm⁻¹.

In the negative electrode active material particles of Comparative Examples, partial surface erosion schematically illustrated in FIG. 4 was observed in a cross-sectional SEM image of the particles after the cycle test. In the negative electrode active material particles of Examples, a SEI film was formed on the surface of each particle, and such erosion was not observed.

The reason for this is believed to be as follows. The reactivity of the SiOₓ particles of Examples is high, and thus the SEI film is easily formed on the surface of each of the particles. Furthermore, the crystallinity of coating carbon is low, and thus an electrolytic solution is easily permeated. As a result, the SEI film is uniformly formed on the surface of each of the SiOₓ particles, which reduces the side reaction with the electrolytic solution.

The use of coating carbon having low crystallinity makes it difficult to generate cracks of the coating carbon due to expansion and shrinkage of SiOₓ particles during charge and discharge. This may decrease an area of the SiOₓ particles that are partly in direct contact with an electrolytic solution and thus the degradation of an active material due to the side reaction can be reduced.

FIG. 6 shows IR spectra of the negative electrode active material particles B1 to B3 in Examples. The negative electrode active material particles B1 to B3 were treated at different heat treatment temperatures of 1000° C., 900° C., and 1100° C., respectively, when the coating carbon was formed. It is known that, when an SiOₓ active material is heat-treated at 800° C. or more, the crystallinity of Si increases and disproportionation occurs, but there is no significant difference between the IR spectra (intensity ratios (I₉₀₀/Iₘₐₓ)). Therefore, the difference between the IR spectra of the SiOₓ active materials in Examples and Comparative Examples is believed to be not made by the heat treatment performed on the SiOₓ active materials.

### REFERENCE SIGNS LIST

10 negative electrode
11 negative electrode current collector
12 negative electrode active material layer
13,13a,13b negative electrode active material
14 base particle
15 coating layer
16 surface film
100 carbon-coated SiOₓ particle
101 SiOₓ particle
102r crack
B1,B2,B3 negative electrode active material particle

1. A particulate negative electrode active material used for a nonaqueous electrolyte secondary battery, the negative electrode active material comprising:
a particle composed of silicon oxide; and
a coating layer that is composed of a conductive carbon material and coats at least part of a surface of the particle,
wherein, a ratio of an intensity at 900 cm⁻¹ to a maximum peak intensity at 600 cm⁻¹ to 1400 cm⁻¹ in an infrared absorption spectrum obtained by infrared spectroscopic measurement is 0.30 or more, and a full width at half maximum of a peak near 1360 cm⁻¹ in a Raman spectrum obtained by Raman spectroscopic measurement is 100 cm⁻¹ or more.

2. The negative electrode active material according to claim 1,
wherein the intensity at 900 cm⁻¹ in the infrared absorption spectrum is 0.35 to 0.45.

3. A negative electrode for a nonaqueous electrolyte secondary battery, comprising:
a negative electrode current collector; and
a negative electrode active material layer that is formed on the negative electrode current collector and that contains the negative electrode active material according to claim 1.

4. The negative electrode for a nonaqueous electrolyte secondary battery according to claim 3,
wherein the negative electrode active material layer further contains a carbon-based negative electrode active material.

5. A nonaqueous electrolyte secondary battery comprising the negative electrode according to claim 3, a positive electrode, and a nonaqueous electrolyte.

6. The nonaqueous electrolyte secondary battery according to claim 5,
wherein the negative electrode active material includes a surface film with lithium ion conductivity, the surface film being formed on the surface of the particle.
